(19) United States
(12) Patent Application Publication
(10) Pub. No.: US 2015/0093475 A1
(43) Pub. Date: Apr. 2, 2015

(54) Method for Facilitating Selection of a Pet Food

(71) Applicant: Brad Gutting, St. Louis, MO (US)

(72) Inventor: Brad Gutting, St. Louis, MO (US)

(21) Appl. No.: 14/038,794

(22) Filed: Sep. 27, 2013

(51) Int. Cl. A23K 1/18

(52) U.S. Cl. CPC A23K 1/1846
USPC 426/87; 426/383

(57) ABSTRACT

A method for facilitating the selection of a pet food based on the nutrient sources. A first pet food product and a second pet food product can be provided. Each pet food product can be put in a package and each package can have a primary nutrient source region with protein source indicia and a secondary nutrient region with secondary nutrient source indicium. The protein source indicia on the first and second package can be different. The primary source region and the secondary source region can comprise great than about 50% of the area of the front side of the package.

### FIELD OF THE INVENTION

This invention relates to a method for facilitating selection of a pet food to provide a pet with a food with the desired nutrients.

### BACKGROUND OF THE INVENTION

Currently, there are a multitude of foods specially formulated for pets. When a consumer looks in the pet food section of a store or online retailer she is faced with many brands of pet foods and each brand of pet food often has multiple products. For instance, in the dog food section a single brand can offer dry foods, wet foods, foods based on life stage such as puppy, adult, and senior; foods with different protein sources such as chicken, fish, lamb, bison, beef; foods to provide a specific benefit (e.g. healthy skin and coat formulations or formulations to support hip and joint health), weight maintenance formulations, and grain free foods for dogs with allergies or perceived allergies.

With all of the choices, it can be difficult for a consumer to determine what nutrient sources or flavors are in the pet food that she is purchasing. It can be especially confusing to buy a pet food when the products in a certain brand are all packaged similarly. For instance, some brands use the same graphics across their entire product lineup, even though the nutrient sources or flavors vary in different products. Furthermore, many brands do not have any graphics printed on the package that represent the nutrient sources in the formulations, requiring the consumer to lift the package, which can weigh between 5 lbs. (2.3 kg) and 30 lbs. (13.6 kg), to read the ingredient list on the back side.

Furthermore many consumers are concerned about choosing the proper diet for their pets. For instance, some pets have allergies or perceived allergies and consumers want to avoid certain ingredients such as beef, corn, wheat, soy, eggs, and/or milk. However, current packaging can make it difficult to identify these ingredients and consumers can accidentally purchase the wrong pet food.

Other consumers prefer rotation feeding and want to vary the nutrient sources. Current packaging makes it difficult to tell what nutrient sources are in the pet food. This is especially true for secondary nutrient sources, as many brands do not depict or have highly visible text highlighting the secondary nutrient sources. If the consumer wishes to determine some of the nutrient sources, she must generally read the full ingredient list on the back side of the package.

Still other consumers may anthropomorphize their pets' desired eating experience, and want to provide variety as a way of expressing affection and/or treating a pet like a human member of the family. These consumers may seek different nutrient sources and/or flavors of food as a way of providing a pet with more interesting, enjoyable meals relative to repeatedly serving the same flavor of the same food.

There remains a need for a method to facilitation quick and easy selection of the appropriate pet food product in an array of packages that clearly depicts the protein source and some secondary sources on the front side of the individual product packages.

### SUMMARY OF THE INVENTION

A method for facilitating the selection of a pet food based on the nutrient sources comprising: providing a first pet food product with a first package comprising a front side wherein the front side comprises a first primary nutrient source region comprising a first protein source indicium; and a first secondary nutrient region comprising a first secondary nutrient source indicium wherein the first primary nutrient source region and the first secondary nutrient region comprise greater than about 50% of the area of the front side of the first package; and providing a second pet food with a second package comprising a front side wherein the front side comprises a second primary nutrient source region comprising a second protein source indicium; and a second secondary nutrient region comprising a second secondary nutrient source indicium wherein the second primary nutrient source region and the second secondary nutrient region comprise greater than about 50% of the area of the front side of the second package; and wherein the first protein source indicium and the second protein source indicium are different.

An array of pet food products that facilitate selection of a pet food based on the nutrient sources comprising: providing a first pet food product with a first package comprising a front side and a left side wherein the front side comprise a first formulation identifier; a first primary nutrient source region comprising a first protein source indicium; a first secondary nutrient region comprising a first secondary nutrient source indicium wherein the first primary nutrient source region and the first secondary nutrient region comprise greater than about 60% of the area of the front side of the first package; and providing a second pet food with a second package comprising a front side and a left side wherein the front side comprises a second formulation identifier; a second primary nutrient source region comprising a second protein source indicium; a second secondary nutrient region comprising a second secondary nutrient source indicium wherein the second primary nutrient source region and the second secondary nutrient region comprise greater than about 60% of the area of the front side of the second package; and wherein the first protein source indicium and the second protein source indicium are different.

### BRIEF DESCRIPTION OF THE DRAWINGS

FIG. 1 is front view of an exemplary package;

FIG. 2 is a front view of a second exemplary package; and

FIG. 3 is a front view of a third exemplary package.

### DETAILED DESCRIPTION OF THE INVENTION

Consumers have a difficult time selecting the desired pet food product amongst the multitude of pet foods at the store or online retailer. The selection process can be even more confusing because many pet food products look alike and it can be difficult to tell what nutrient sources and/or flavors are in the pet food without reading the ingredient list on the back side of the package.

In some aspects, the present disclosure relates to a method of facilitating selection of the desired and appropriate pet food product. The consumer can determine some of the nutrient sources by looking at graphic indicia depicting the nutrient sources on the front side of the package. In one example, the graphic indicia can depict one or more primary nutrient sources and one or more secondary nutrient sources. In another example, the primary nutrient source can be a protein source. In one example, the graphic indicia are photographs that represent some ingredients in the pet food. The graphic indicia help facilitate the consumer's quick and easy selection of a pet food product by depicting some of the nutrient sources in the product and helping her determine some of the differences between the products, by looking at the front side of the package.

Furthermore, each product in the lineup has a different formulation identifier. In one example, the formulation identifier can be a background color that can be visible on the front, left side, right side, top, and/or base of the package and gives another indication about the different formulas. The formulation identifier also helps the consumer to immediately recognize that she is looking at a different formulation because it is a point of distinction between the packages.

The primary nutrient and/or secondary nutrient graphic indicium and/or indicia can focus on elements associated with a particular kind of nutrient source to help facilitate selection of a pet food. In one example, the graphic indicium focuses on certain properties of the ingredients, for instance the marbling or lack thereof in red meats such as beef or bison. In another example, the graphic indicium can magnify the nutrient source to highlight a particular quality of the ingredient. In another example, the graphic indicium depicts nutrient sources that are unique to the product or a nutrient source that provides a particular vitamin, mineral, fiber, or other nutrient that is present in the pet food product.

The front side of the package can have a primary nutrient source region with graphic indicium of the primary nutrient source and/or a secondary nutrient source region with graphic indicium of secondary nutrient sources. In one example, the primary nutrient source region and/or the secondary source region can comprise at least about 33% of the package each. The relatively large primary nutrient source region and/or secondary nutrient source region can make the nutrient sources a focus of the packaging and can facilitate easier and faster pet food selections.

In one example, the primary nutrient source region can be located at or near the top of the package. This can make the primary nutrient source highly visible to consumers. In another example, the secondary nutrient source region can be located at or near the bottom of the package.

In another example, the products can be arranged in an array. The array can include a first product and a second product. In another example, the array can include a third product, in another example a fourth product, in another example a fifth product, and in another example a sixth product. In one example, the array has one or more pet food products formulated for consumption by dogs and one or more pet food products formulated for consumption by cats. In another example, the array only has pet food products that are formulated for dogs or cats. In one example, the array is shelved together and each product in the array has a different formula identifier, which allows the user to quickly determine when the formulation has changed especially when the bags are stacked, as they are at many retailers.

As used herein, “indicia” provides information to a consumer. The indicia can include many forms and present the information in many ways and in many types of media. Non-limiting examples of types of indicia include alpha-numeric indicia, pictures, drawings, illustrations, photographs, computer-produced images, colors, sounds, textures, shapes, icons, symbols, and combinations thereof. As used herein, “graphic indicia” can include an image that provides information to a consumer. Non-limiting examples of types of graphic indicia can include pictures, drawings, illustrations, photographs, computer-produced images, icons, symbols, and combinations thereof.

As used herein “nutrient” refers to any desired dietary substance, including, without limitation, vitamins, minerals, proteins, amino acids, fatty acids, fats, carbohydrates, fiber and fiber-sources, starches, co-vitamins, drugs or medications, and the like. “Nutrient” may, where so described, refer to a particular ratio of substances, such as, for example, the ratio of omega-6 fatty acids to omega-3 fatty acids, or the ratio of insoluble fiber to soluble fiber. As used herein, “nutrient” does not extend to palatants, flavorings, colorants, or other additives which may be used to differentiate animal diets with no significant change in the nutritional value of the diets.

As used herein “nutrient source” can include primary nutrient sources or secondary nutrient sources. In one example, primary nutrient sources can be protein sources.

Protein sources can include animal protein sources and plant protein sources. Non-limiting examples of animal protein can include beef, bison, pork, chicken, turkey, lamb, kangaroo, shell fish, fish (including salmon, whitefish, herring, and tuna), alligator, goat, animal milk proteins, and combinations thereof. Non-limiting examples of plant proteins can include lupin protein, wheat protein, soy protein, and combinations thereof.

Non-limiting examples of secondary nutrient sources can include farinaceous matter, vegetables, fruits, and combinations thereof.

The farinaceous matter is commonly known in the pet food industry. Non-limiting examples of farinaceous matter include grains such as, rice, corn, milo, sorghum, barley, and wheat, and the like, pasta (for example, ground pasta), breading, and combinations thereof.

Non-limiting examples of vegetables can include peas, carrots, corn, potatoes, sweet potatoes, tomatoes, beans, cabbage, tomatoes, celery, broccoli, cauliflower, leeks, pumpkin, squash and combinations thereof.

Non-limiting examples of fruits can include apples, avocado, pears, peaches, cherries, apricots, plums, grapes, oranges, grapefruit, lemons, limes, cranberries, raspberries, blueberries, watermelon, cantaloupe, honeydew melon, strawberries, banana, and combinations thereof.

As used herein, “pet” means dogs, cats, small mammals such as gerbils, hamsters, chinchillas, rats, rabbits, guinea pigs, and mustelids including ferrets and skunks, and/or other domesticated animals.

As used herein, the articles “a” and “an” when used herein, for example, “an image ” or “a protein source” is understood to mean one or more of the material that is claimed or described.

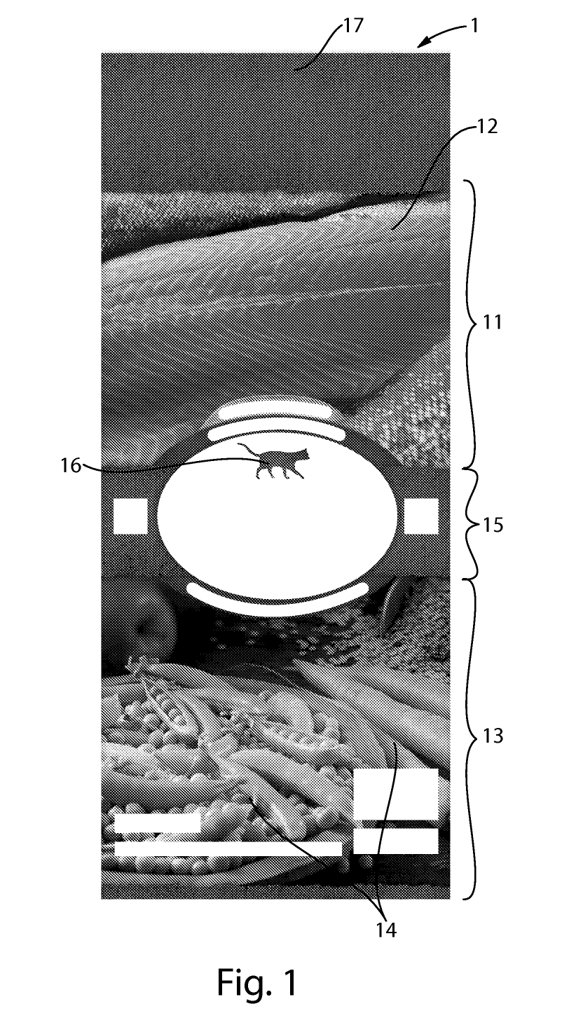

FIG. 1 shows a front side 1 of an exemplary package of the present invention. Front side 1 comprises a primary nutrient source region 11 comprising protein source graphic indicium 12 and a secondary nutrient source region 13 with secondary nutrient source graphic indicia 14. In this example, the protein source graphic indicium 12 is a photograph of a salmon filet and the secondary source graphic indicia 14 is a photograph of peas, carrots, an apple and grains. The protein source graphic indicium and secondary nutrient graphic indicium can depict anything that would conjure an image of the nutrient source in the consumer's mind. For instance, the protein source graphic indicium can depict the living animal or a portion of the living animal, muscle meat, ground meat, texturized protein, the plant that produced the plant protein, and combinations thereof.

Front side 1 can also include a brand identification region 15. The brand identification region 15 can include the brand name, the product name, trademarks, a brief description of the product including but not limited to a few nutrient sources, the life stage of the animal that the product is intended to be consumed by (e.g. adult cat, adult dog, senior cat, senior dog, kitten, puppy, etc.) and combinations thereof. Brand identification region 15 can comprise less than about 40% of the area on the front side of the package, in another example less than about 35%, in another example less than about 33%, in another example less than about 30%, in another example less than about 25%, in another example less than about 20%, in another example less than about 15%, in another example less than about 15%, and in another example less than 10%.

In one example, brand identification region 15 can include pet identifier indicium 16. The pet identifier indicium can be any indicium, including, but not limited to, a graphical representation of the pet that the food is formulated for. In FIG. 1, pet identifier indicium 16 is an icon of a cat. The pet identifier indicium can be any size. In one example, the pet identifier indicium comprises less than about 15% of the area of the front side of the package, in another example less than about 10%, in another example less than about 7%, and in another example less than about 5%.

Front side 1 can also include formulation identifier 17.

The formulation identifier provides another means for a consumer to select a product. For instance, a consumer may know that she buys the formulation with a particular formulation identifier, for instance a purple bag, and will easily be able to identify that formulation amongst other products. The formulation identifier can be any indicia. Non-limiting examples of formulation identifiers include textures, patterns, colors, and combinations thereof. In one example, the formulation identifier is a color and each formulation can have a different color.

In one example, formulation identifier 17 can be present on front side 1 of the package in all of the areas that are not occupied by primary nutrient source region 11, secondary nutrient source region 13, and brand identification region 15. In other examples the formulation identifier can be in the areas occupied by the primary nutrition source region, the brand identification region, and the secondary nutrient region, possible as a background color. In other words, formulation identifier 17 can act as a background for the other regions. Formulation identifier 17 can also carry over to the right side, left side, backside and/or of the package. It can be important to have the formulation identifier on the side panels and the top and bottom portions of the front side because these can be visible at the retailer, especially since pet food products are often stacked horizontally.

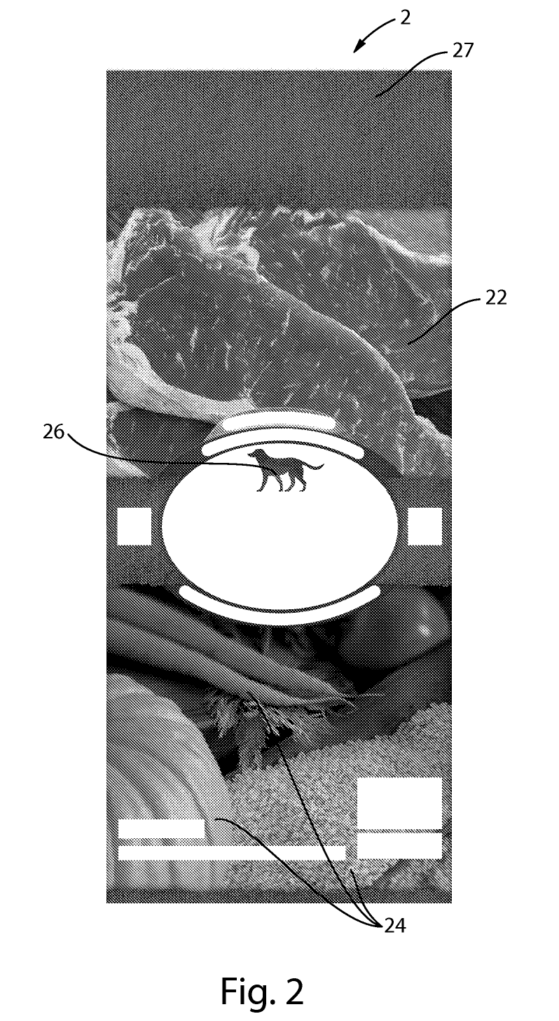

FIG. 2 shows a front side 2 of an exemplary package of the present invention. Front side 2 has a similar layout to front side 1, in FIG. 1, however protein source indicium 22, secondary nutrient source indicia 24, pet identifier 26, and formulation identifier 27 are different. Protein source indicium 22 is a photograph of beef which includes some marbling, secondary nutrient source indicia 24 is a photograph of red lentils, pumpkin, and carrots, and the pet identifier 26 is a dog icon, as this product is formulated for dogs. Formulation identifier 27 is a different color than FIG. 1, however both have the same texture. The similar layout to FIG. 1 helps a user recognize that the packages in FIG. 1 and FIG. 2 are from the same brand.

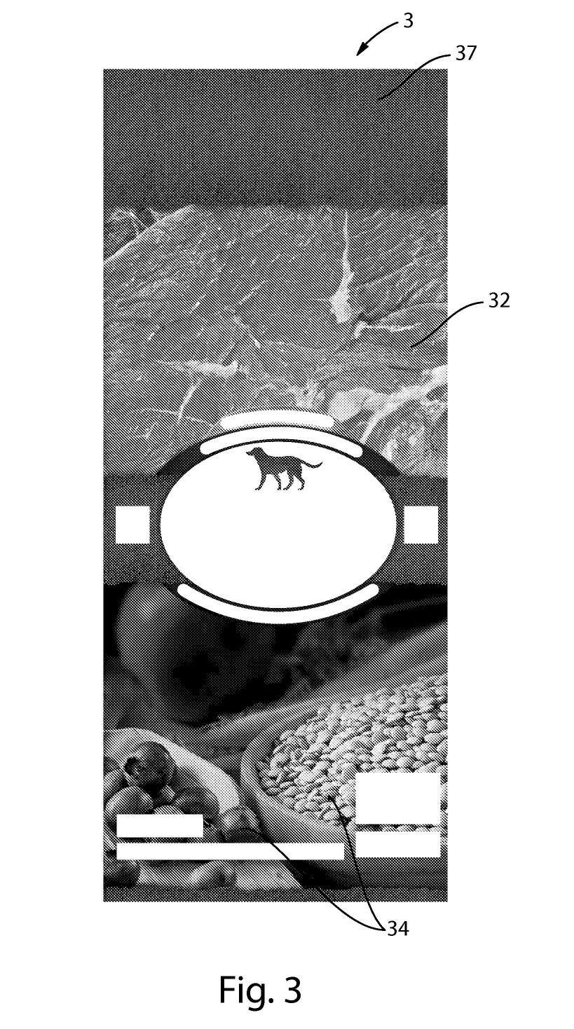

FIG. 3 shows a front side 3 of an exemplary package of the present invention. Front side 3 has a similar layout to front side 2, in FIG. 2, however, protein source indicium 32, secondary nutrient source indicia 34, and formulation identifier 37 are different. Protein source indicium 32 is a photograph of bison meat, which has less marbling than the beef in FIG. 2, which can indicate a lean meat. Secondary nutrient source indicia 34 is a photograph depicting lentils and blueberries, and formulation identifier 37 is a different color than formulation identifiers 17 and 27 in FIGS. 1 and 2, however all three formulation identifiers have the same texture.

The primary nutrient source region, the secondary nutrient source region, and the brand identification region can be located anywhere on the package. In one example, the brand identification region can be located adjacent to the primary nutrient source region and/or the secondary nutrient source region. In another example, the primary nutrient source region and the secondary nutrient identification region can be adjacent to one another. In one example the brand identification region is located at or near the top of the front side of the package, in another example at or near the bottom, and another example at or near the center. In another example, the primary nutrient source region can be located at or near the top of the front side of the package, in another example at or near the middle, and in another example at or near the bottom. In another example, the secondary nutritive source region can be located at or near the top of the front side of the package, in another example at or near the middle, and in another example at or near the bottom.

In combination, the primary nutrient source region and the secondary nutrient source region can comprise greater than about 45% of the area of the front side, in another example greater than about 50%, in another example greater than about 60%, in another example greater than about 65%, in another example greater than about 70%, and in another example greater than about 75% of the entire package. Separately, the primary nutrient source region or the secondary nutrient source region can comprise from about 10% to about 60% of the area of the front side, in another example from about 15% to about 55% of the front side, in another example from about 20% to about 50%, and in another example from about 25% to about 45%, and in another example from about 30% to about 40%. The primary nutrient source region and the secondary nutrient source region can be approximately the same size or can be different sizes. In one example the secondary nutrient source region is larger than the primary nutrient source region. In another example, the primary nutrient source region can be larger than the secondary nutrient source region.

The primary nutrient source region can include graphic indicia for all or some of the primary nutrient sources in the pet food contained in the package. In one example, the graphic indicium depicts only one protein source, which can be the primary ingredient in the pet food, by weight % of the pet food. In one example, the graphic indicium depicts only one protein source that has the most noticeable taste in the pet food. In another example, the graphic indicium depicts two primary nutrient sources and in another example, more than two primary nutrient sources.

The secondary nutrient source region can include graphic indicia for all or some of the secondary nutrient sources in the pet food contained in the package. In one example, the graphic indicium depicts only one secondary nutrient source, in another example two secondary nutrient sources, in another example three secondary nutrient sources, in another example four secondary nutrient sources, in another example five secondary nutrient sources, and in another example six secondary nutrient sources. In one example, the graphic indicium depicts the secondary nutrient source that is the primary secondary nutrient source, by weight % of the pet food. In another example, the graphic indicium depicts at least one secondary nutrient source that provides a nutrient that is different than other products that are sold under the same brand.

The package itself may be a bag, box, jar, crate, can, pouch, tub, or any suitable package. The package may contain the diet and prevent it from dispersing or leaking during transportation and storage (as if the diet is provided in bite-sized kibble or other relatively small, easily dispersed particles or aliquots, or in a wet form). The package may reduce or prevent the movement of moisture, air, or other substances between the inside and the outside of the package, as to reduce the likelihood that the diet inside the package will become stale, too dry, too moist, or contaminated during transportation and storage. The package may be resealable.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method for facilitating the selection of a pet food based on the nutrient sources comprising:
providing a first pet food product with a first package comprising a front side wherein the front side comprises:
a first primary nutrient source region comprising a first protein source indicium; and
a first secondary nutrient region comprising a first secondary nutrient source indicium wherein the first primary nutrient source region and the first secondary nutrient region comprise greater than about 50% of the area of the front side of the first package; and
providing a second pet food with a second package comprising a front side wherein the front side comprises:
a second primary nutrient source region comprising a second protein source indicium; and
a second secondary nutrient region comprising a second secondary nutrient source indicium wherein the second primary nutrient source region and the second secondary nutrient region comprise greater than about 50% of the area of the front side of the second package; and
wherein the first protein source indicium and the second protein source indicium are different.

2. The method of claim 1 wherein a least one indicia of the first secondary nutrient source indicium is different than the second secondary nutrient source indicium.

3. The method of claim 1 wherein the front side of the first package further comprises a first brand identification region wherein the first brand identification region comprises less than about 30% of the area on the front side and wherein the front side of the second package further comprises a second brand identification region wherein the first brand identification region comprises less than about 30% of the area on the front side.

4. The method of claim 3 wherein the first brand identification region is approximately in the center of the front side of the first package and wherein the second brand identification region is approximately in the center of the front side of the second package.

5. The method of claim 1 wherein the front side of the first product further comprises a top and wherein the first primary nutrient source region is located near the top and wherein the front side of the second product further comprises a top and wherein the second primary nutrient source region is located near the top of the second package.

6. The method of claim 1 wherein the front side of the first package further comprises a first pet identifier wherein the first pet identifier comprises less than about 15% of the area of the front side of the package and wherein the front side of the second package further comprises a second pet identifier and wherein the second pet identifier comprises less than about 15% of the area of the front side of the package.

7. The method of claim 6 wherein the first pet identifier and the second identifier are the same.

8. The method of claim 7 wherein the first pet food is formulated for a dog.

9. The method of claim 6 wherein the first pet identifier and the second pet identifier are different.

10. The method of claim 9 wherein the first pet food product is formulated for a cat and wherein the second pet food product is formulated for a dog.

11. The method of claim 1 wherein the front side of the first package further comprises a first formulation identifier and wherein the front side of the second package further comprises a second formulation identifier and wherein the first formulation identifier and the second formulation identifier are different colors.

12. An array of pet food products that facilitate selection of a pet food based on the nutrient sources comprising:
providing a first pet food product with a first package comprising a front side and a left side wherein the front side comprises:
a first formulation identifier;
a first primary nutrient source region comprising a first protein source indicium;
a first secondary nutrient region comprising a first secondary nutrient source indicium wherein the first primary nutrient source region and the first secondary nutrient region comprise greater than about 60% of the area of the front side of the first package; and
providing a second pet food with a second package comprising a front side and a left side wherein the front side comprises:
a second formulation identifier;
a second primary nutrient source region comprising a second protein source indicium;
a second secondary nutrient region comprising a second secondary nutrient source indicium wherein the second primary nutrient source region and the second secondary nutrient region comprise greater than about 60% of the area of the front side of the second package;
and wherein the first protein source indicium and the second protein source indicium are different.

13. The array of claim 12 wherein the left side of the first package further comprises the first formulation identifier and wherein the left side of the second package further comprises the second formulation identifier.

14. The array of claim 13 wherein the first formulation identifier and the second formulation identifier are different colors.

15. The array claim 13 wherein the first protein source indicium and the second protein source indicium are selected from the group consisting of beef, bison, pork, chicken, turkey, lamb, kangaroo, shell fish, fish, alligator, goat, and combinations thereof.

16. The array of claim 13 wherein the first secondary nutrient source indicium and the second secondary nutrient source indicium are selected from the group consisting of farinaceous matter, vegetables, fruits, and combinations thereof.

17. The array of claim 13 wherein the first pet food product and the second pet food product are intended to be consumed by a dog.

18. The array of claim 13 wherein the first protein source indicium is muscle meat.

19. The array of claim 13 further comprising a third pet food product wherein the third pet food product comprises a front side and wherein the front side comprises a third primary nutrient source region comprising a third protein source indicium and a third secondary nutrient region comprising a third secondary nutrient source indicium wherein the third primary nutrient source comprises greater than about 60% of the area of the front side of the third package and wherein the first protein source indicium, the second protein source indicium, and the third protein source indicium are different.

20. The array of claim 19 wherein the first protein source indicium is bison, the second protein source indicium is beef, and the third protein source indicium is fish.
